(19) United States
(12) Patent Application Publication
(10) Pub. No.: US 2017/0126951 A1
(43) Pub. Date: May 4, 2017

(54) UPDATING AN EXPOSURE TABLE OF AN IMAGE SENSOR

(71) Applicant: Motorola Mobility LLC, Chicago, IL (US)

(72) Inventors: Qiaotian Li, Chicago, IL (US); Chekit R Mehta, Buffalo Grove, IL (US)

(21) Appl. No.: 14/932,277

(22) Filed: Nov. 4, 2015

(51) Int. Cl. H04N 5/235; H04W 4/02

(52) U.S. Cl. CPC H04N 5/2357; H04W 4/025; H04N 5/2353

(57) ABSTRACT

A method, a system, and computer program product for updating a current exposure table that is used by an image sensor in order to prevent alternating current (AC) frequency banding due to incandescent or fluorescent lights in a camera preview, a captured video, and/or captured still images. The method includes detecting a condition that triggers an update to a current exposure table that is used by at least one image sensor of a device. A suitable exposure table for potential use by the at least one image sensor is then determined. The suitable exposure table is then evaluated to determine whether the suitable exposure table is equivalent to the current exposure table. In response to determining the suitable exposure table is not equivalent to the current exposure table, the suitable exposure table is applied to the at least one image sensor.

### BACKGROUND

1. Technical Field

The present disclosure generally relates to image capturing systems and in particular to an improved method for updating a current exposure table used by an image sensor.

2. Description of the Related Art

Flickering of incandescent or fluorescent lights operating on alternating current (AC) power may be captured by a rolling shutter of a digital image sensor. This occurrence can result in the appearance of banding in a camera preview presented within a viewfinder or in captured video or still images. The resulting banding appears as both dark and bright banding regions due to pixels of the image sensor being exposed at different times in an AC power waveform. The appearance of banding is highly undesirable since the banding significantly degrades image quality in a camera preview and in captured video and still images.

Some software solutions currently exist that use an image sensor to first detect the presence of flickering caused by the presence of AC powered lighting in an environment, prior to capturing an image. In response to detecting flickering caused by AC lighting, a new exposure table may be applied to an image sensor that mitigates the issue. However, this solution requires a camera module be programmed with additional software to detect the flickering. Additionally, this solution also requires that an image sensor and (any associated software) first detect the flickering before an image without banding can be captured. Otherwise, banding will still exist in a camera preview or in captured video/images.

Another solution exists where a software can digitally alter captured images/video to remove banding caused by an AC incandescent or fluorescent lighting. However, this solution requires a system individually process each image or video exhibiting banding artifacts to remove the artifacts.

### BRIEF DESCRIPTION OF THE DRAWINGS

FIG. 1 provides a block diagram representation of an example system within which certain aspects of the disclosure can be practiced, in accordance with one or more embodiments;

FIG. 2 illustrates an example exposure selection component that updates a current exposure table used by at least one image sensor in order to prevent the capture of banding regions caused by AC power, in accordance with one or more embodiments;

FIG. 3 is a flow chart illustrating a method for applying a suitable exposure table to at least one image sensor, in accordance with one or more embodiments;

FIG. 4 is a flow chart illustrating a method for retrieving an exposure table for potential use by at least one image sensor responsive to receiving a location code associated with a cellular network provider, in accordance with one or more embodiments;

FIG. 5 is a flow chart illustrating a method for retrieving an exposure table for potential use by at least one image sensor of a device based on a device identifier associated with the device, in accordance with one or more embodiments;

FIG. 6 is a flow chart illustrating a method for retrieving an exposure table used by at least one image sensor of a device based on a current location of the device, in accordance with one or more embodiments; and

FIG. 7 is a flow chart illustrating a method for retrieving an exposure table used by at least one image sensor in response to detecting at least one proximate wireless network, in accordance with one or more embodiments.

### DETAILED DESCRIPTION

The illustrative embodiments provide a method, a system, and a computer program product for updating a current exposure table that is used by an image sensor in order to prevent AC frequency banding due to incandescent or fluorescent lights in a camera preview, a captured video, and/or captured still images. The method includes detecting a condition that triggers an update to a current exposure table that is used by at least one image sensor of a device. The method then includes determining a suitable exposure table for potential use by the at least one image sensor. The suitable exposure table is then evaluated to determine whether the suitable exposure table is equivalent to the current exposure table. In response to determining the suitable exposure table is not equivalent to the current exposure table, the suitable exposure table is applied to the at least one image sensor. The at least one image sensor then subsequently uses the suitable exposure table when providing a camera preview within a viewfinder of a device and/or when capturing still images and/or video.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the following figures and the remaining detailed written description. The above as well as additional objectives, features, and advantages of the present disclosure will become apparent in the following description.

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

As utilized herein, a suitable exposure table refers to an exposure table that when applied to an image sensor prevents the appearance of banding in image data captured by the image sensor (e.g., a camera preview, video, and still images), where such banding is caused by the flickering of incandescent or fluorescent lighting operating on AC power (e.g., 50 Hertz (Hz) or 60 Hz AC power). More particularly, the suitable exposure table defines one or more exposure timings that can be used by the one or more image sensors of a device in order to synchronize the timing that image data is captured by the one or more image sensors based on the frequency of an AC power source in a particular region/environment. In one embodiment, the exposure timings provided in a suitable exposure table are based on the below formula, where n is a whole number and f is the frequency of the AC power:

$$timing = n ( \frac{1}{2 * f} )$$

For example, in a particular region where incandescent or fluorescent lighting is operating on 50 hz AC power, the timing(s) provided by a suitable exposure table should be a multiple of 10 ms (i.e., 10 ms, 20 ms, 30 ms, etc.). Similarly, in a particular region where incandescent or fluorescent lighting is operating on 60 hz AC power, the timing(s) provided by a suitable exposure table should be a multiple of 8.33̅ ms (8.33̅ ms, 16.66̅ ms, 24.99̅ ms, etc.). By applying the suitable exposure table to an image sensor, a rolling shutter of the image sensor utilizes timings that are based on the same frequency as that of the AC power source, which prevents the appearance of banding in image data captured by the image sensor.

Those of ordinary skill in the art will appreciate that the hardware components and basic configuration depicted in the following figures may vary. For example, the illustrative components within data processing system 100 are not intended to be exhaustive, but rather are representative to highlight essential components that are utilized to implement the present disclosure. For example, other devices/components may be used in addition to or in place of the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

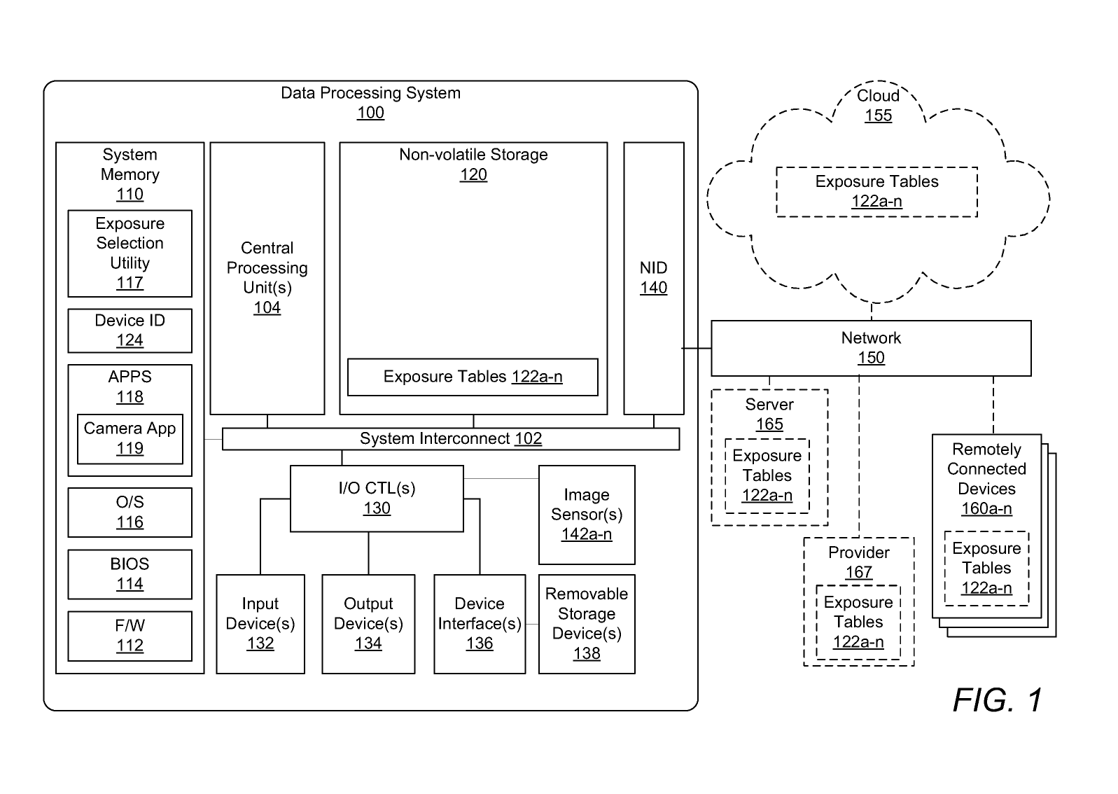

With reference now to the figures, and beginning with FIG. 1, there is depicted a block diagram representation of an example data processing system (DPS) 100, within which one or more of the described features of the various embodiments of the disclosure can be implemented. In one embodiment, DPS 100 can be any personal device such as a desktop computer, notebook computer, mobile phone, tablet, or any other electronic device that supports image or video capturing. Data processing system 100 includes at least one central processing unit (CPU) or processor 104 coupled to system memory 110 via system interconnect 102. System interconnect 102 can be interchangeably referred to as a system bus, in one or more embodiments. These one or more software and/or firmware modules can be loaded into system memory 110 during operation of DPS 100. Specifically, in one embodiment, system memory 110 can include therein a plurality of such modules, including one or more of firmware (F/W) 112, basic input/output system (BIOS) 114, operating system (OS) 116, exposure selection utility (ESU) 117, and application(s) 118. In one embodiment, applications 118 may include camera application 119. These software and/or firmware modules have varying functionality when their corresponding program code is executed by CPU 104 or secondary processing devices within data processing system 100.

In one embodiment, system memory 110 may include a device identifier (ID) 124. Device ID 124 may contain identifying or descriptive information of DPS 100 or any hardware or software components therein, including identifying or descriptive information of image sensor(s) 142a-n. The identifying or descriptive information may include, for example, a serial number, a sku number, and/or a model number. In an embodiment, device ID 124 is stored within non-volatile storage 120.

ESU 117 is a utility that executes within DPS 100 to provide logic that performs the various method and functions described herein. For simplicity, ESU 117 is illustrated and described as a stand-alone or separate software/firmware/logic component, which provides the specific functions and methods described below. However, in at least one embodiment, ESU 117 may be a component of or may be combined with or incorporated within firmware of DPS 100, the OS 116, and/or one or more of applications 118, such as a camera application 119.

Data processing system 100 further includes one or more input/output (I/O) controllers 130, which support connection by and processing of signals from one or more connected input device(s) 132, such as a keyboard, mouse, hardware button(s), touch screen, infrared (IR) sensor, fingerprint scanner, or microphone. Also coupled to I/O controllers 130 are at least one image sensor 142a-n that is usable to provide a camera preview for DPS 100 and/or capture still images or video. I/O controllers 130 also support connection with and forwarding of output signals to one or more connected output devices 134, such as monitors and audio speaker(s). Additionally, in one or more embodiments, one or more device interfaces 136, such as an optical reader, a universal serial bus (USB), a card reader, Personal Computer Memory Card International Association (PCMIA) slot, and/or a high-definition multimedia interface (HDMI), can be associated with DPS 100. Device interface(s) 136 can be utilized to enable data to be read from or stored to corresponding removable storage device(s) 138, such as a compact disk (CD), digital video disk (DVD), flash drive, or flash memory card. In one or more embodiments, device interfaces 136 can further include General Purpose I/O interfaces, such as I²C, SMBus, and peripheral component interconnect (PCI) buses.

Also coupled to system interconnect bus 102 is nonvolatile storage 120, within which can be stored exposure tables 122a-n. While exposure tables 122a-n are illustrated within nonvolatile storage 120, exposure tables 122a-n may also be stored in system memory 110 and/or in one or more external storage repositories (not pictured). Further, exposure tables 122a-n may also be stored and/or accessed by DPS 100 from cloud network 155, remotely connected devices 160a-n, server 165, cellular network provider 167, and other connected devices (not pictured). An exposure table 122 is used by image sensor(s) 142a-n to control a rate of capture of image data by a rolling shutter (not pictured) of the image sensor(s) 142a-n. The image data may include any of a camera preview, still images, and/or video data. In one embodiment, the image sensor is a complementary metal-oxide-semiconductor (CMOS) sensor.

In one embodiment, exposure tables 122a-n may be used to program a dedicated memory of the image sensors 142a-n, which memory contains instructions that enables image sensors 142a-n to provide a camera preview and/or capture still images and video. In another embodiment, image sensor(s) 142a-n may directly reference exposure tables 122a-n from a memory of DPS 100 (e.g., within non-volatile storage 120 or system memory 110).

Data processing system 100 comprises a network interface device (NID) 140. NID 140 enables DPS 100 and/or components within DPS 100 to communicate and/or interface with other devices, services, and components that are located external to DPS 100. In one embodiment, DPS 100 may directly connect to one or more of these external devices, such as cloud network 155, server 165, cellular network provider 167, and/or one or more remotely connected devices 160a-n via NID 140. These devices, services, and components can also interface with DPS 100 via an external network, such as example network 150, using one or more communication protocols. Network 150 can be a local area network, wide area network, personal area network, and the like, and the connection to and/or between network and DPS 100 can be wired or wireless or a combination thereof. For purposes of discussion, network 150 is indicated as a single collective component for simplicity. However, it is appreciated that network 150 can comprise one or more direct connections to other devices as well as a more complex set of interconnections as can exist within a wide area network, such as the Internet. Thus, as shown, DPS 100 may also be connected to server 165 and/or one or more remotely connected devices 160a-n via network 150. Server 165 may facilitate the transmission and/or storage of exposure tables 122a-n. DPS 100, cloud network 155, remotely connected devices 160a-n, cellular network provider 167, and/or any other devices (not pictured) that are connected to server 165 may deposit, retrieve, access, modify, or process exposure tables 122a-n stored within server 165. ESU 117 may configure DPS 100 to download, request, or receive exposure tables 122a-n from any of cloud network 155, remotely connected devices 160a-n, server 165, and/or cellular network provider 167. In one embodiment, ESU 117 may establish a client/server relationship and/or a peer-to-peer connection with any of cloud network 155, remotely connected devices 160a-n, server 165, and/or cellular network provider 167 in order to select and obtain a suitable exposure table from among exposure tables 122a-n.

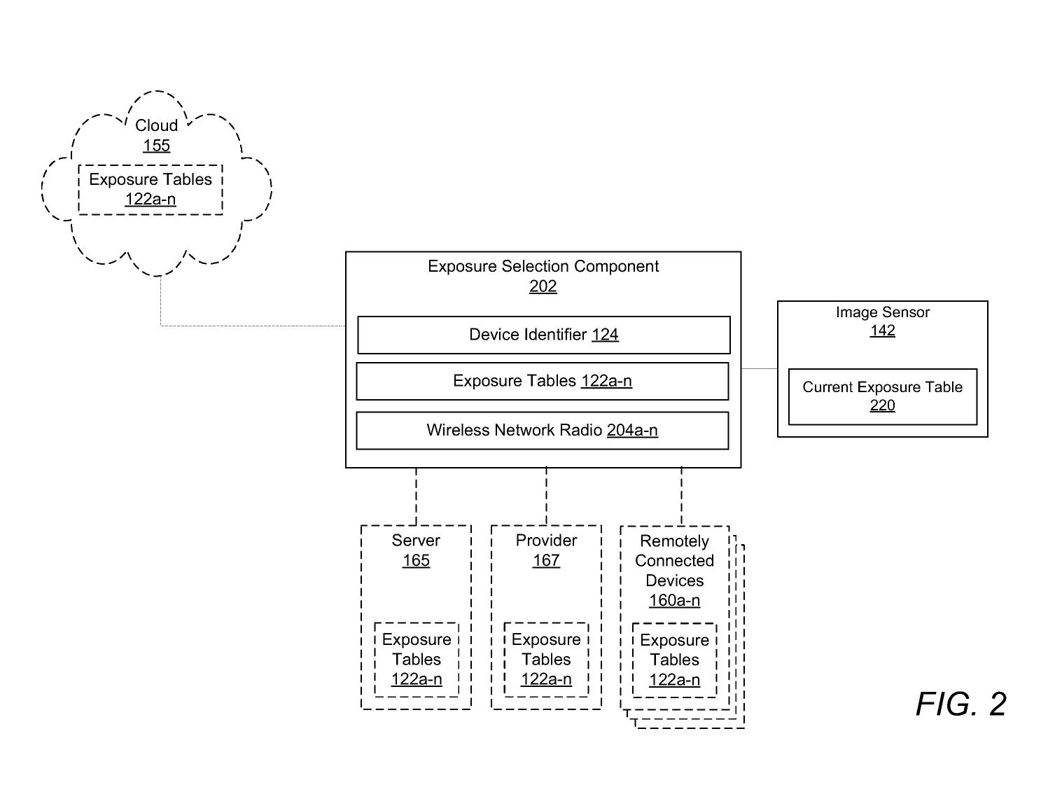

FIG. 2 illustrates an example exposure selection component (ESC) 202 that updates a current exposure table 220 used by at least one image sensor 142 in order to prevent the capture of banding regions caused by AC power, in accordance with one or more embodiments. ESC 202 includes a processor that executes ESU 117. In another embodiment, ESC 202 may be a general purpose data processing system such as DPS 100.

ESC 202 is coupled to at least one image sensor 142 that is configured based on a current exposure table 220. Exposure tables 122a-n may be used to reconfigure image sensor 142. Each of exposure tables 122a-n is configured for use in one or more particular environments, such as a geographic region or particular location. In response to detecting a condition that triggers an update to a current exposure table that is in use by at least one image sensor, ESC 202 may determine a suitable exposure table. The suitable exposure table may be selected from among a plurality exposure tables 122a-n. Exposure tables 122a-n may be stored locally or remotely. For example, ESC 202 may select a suitable exposure table from among a plurality of locally stored exposure tables stored locally within DPS 100 and/or a plurality of exposure tables stored remotely within server 165.

In one embodiment, ESC 202 may autonomously select a suitable exposure table for updating image sensor 142 in response to connecting to cellular network provider 167 or receiving a location code or a location identifier from cellular network provider 167. In one embodiment, the location code is a mobile country code (MCC). In another embodiment, ESC 202 may receive an exposure table pushed to ESC 202 from cellular network provider 167.

ESC 202 may also autonomously select a suitable exposure table for updating image sensor 142 in response to detecting the device's current location. ESC 202 may utilize one or more sensors (not pictured), such as a global positioning satellite (GPS) sensor or a radio frequency identification (RFID) sensor, to identify the device's current location. In one embodiment, ESC 202 may determine a current location of the device by using latitude and longitude coordinate information provided to, or measured by, the device. In another embodiment, ESC 202 may detect the device's current location by triangulating a cellular network signal. In the event ESC 202 cannot determine a current location, ESC 202 may also prompt a user to identify the current location. In response to determining or receiving the current location, ESC 202 determines a particular region that the device is located in. ESC 202 may then select a suitable exposure table that is associated with the determined region.

In yet another embodiment, ESC 202 may autonomously select a suitable exposure table for updating image sensor 142 in response to detecting a device identifier 124 associated with itself and/or one or more hardware and/or software components of ESC 202. Device identifier 124 may be used to select a suitable exposure table that is associated with ESC 202 and/or one or more components of ESC 202. ESC 202 may then retrieve and apply the suitable exposure table to the at least one image sensor. Device identifier 124 may also be associated with a particular geographic region. For example, device identifier 124 may be associated with a geographic region of use where ESC 202 is intended by a manufacturer to be sold.

In still another embodiment, ESC 202 may autonomously select a suitable exposure table for updating image sensor 142 in response to detecting one or more proximate wireless networks, using at least one wireless network radio 204a-n. The one or more proximate wireless networks may include, but are not limited to, any of a personal area network, a wireless local area network, an ad-hoc network, and a personal area network (e.g., Bluetooth® network). ESC 202 determines a particular region where the detected, proximate wireless network is located. In one embodiment, ESC 202 may determine the particular region where the proximate wireless network is located based on, for example, an internet protocol (IP) address of a gateway device in the one or more proximate wireless networks. In another embodiment, the proximate wireless network may be a pre-established proximate wireless network having a location that is already known to ESC 202 (e.g., an office network or a wireless network having a location known to a search entity). Based on the detected region of the at least one proximate wireless network, ESC 202 selects an exposure table that is associated with the particular region. ESC 202 may then retrieve and apply the selected exposure table to the at least one image sensor. In yet another embodiment, ESC 202 may receive a notification from another device connected to the at least one proximate wireless network that identifies a location of the at least one proximate wireless network.

The conditions that may trigger ESC 202 to update a current exposure table 220 can include, but are not limited to: (1) detecting a launch of a camera application that interfaces with the at least one image sensor; (2) booting of the ESC 202 and/or a device connected thereto; (3) detecting a change in a personal area network that the device is connected to; (4) detecting a change in a wireless local area network that the device is connected to; (5) detecting a change in a cellular network that the device is connected to; and (6) detecting a change in a current region where the device is located, from a first region to a second region.

Each exposure table 122 may be associated with one or more environments, device identifiers, locations, location codes, regions, proximate wireless networks, etc. In one embodiment, each exposure table has only a single association. In another embodiment, a particular exposure table 122 may also have multiple associations including associations of different types, as illustrated in Table 1, below.

TABLE 1

| Association | Exposure Table |
|---|---|
| Location A, Device ID B | Exposure Table A |
| Proximate Network N | Exposure Table B |
| . . . | . . . |
| Proximate Network A, Region N, | Exposure Table N |
| Location Code N, Device ID N | |

In one embodiment the associations described in Table 1 are stored within one or more databases (not pictured) that are located within one or more of ESC 202, cloud network 155, remotely connected devices 160a-n, server 165, and/or cellular network provider 167. The exposure tables referenced in these databases may be stored at a same or different location from among ESC 202, cloud network 155, remotely connected devices 160a-n, server 165, and/or cellular network provider 167. ESC 202 utilizes the one or more databases to look up any environment, device identifier, location, location code, region, proximate wireless network, etc. to determine an associated exposure table. In another embodiment, the databases described above also identify one or more locations where each exposure table is stored. Exposure tables 122a-n may be stored in a same or different location as the one or more databases.

One or more of the embodiments described above may further be combined in any order to precisely determine a suitable exposure table. For example, ESC 202 may first attempt to determine a suitable exposure table by identifying an MCC from a cellular network provider. In response to being unable to determine a suitable exposure table using a MCC (for example, due to no cellular network connection being available or the device not having a cellular network radio), ESC 202 may then attempt to determine a suitable exposure table using a device identifier and/or by detecting a proximate wireless network.

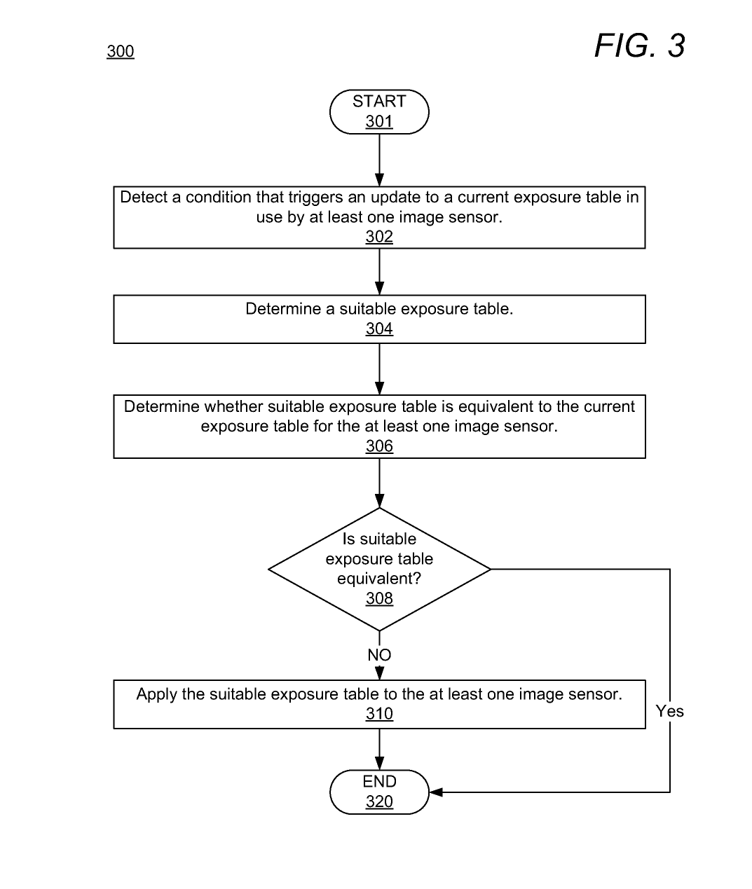

Referring now to FIGS. 3-7, there are illustrated flow charts of various methods for applying a suitable exposure table to at least one image sensor, according to one or more embodiments. Aspects of the methods are described with reference to the components of FIGS. 1-2. Several of the processes of the methods provided in FIGS. 3-7 can be implemented by the CPU 104 executing software code of ESU 117 within a data processing system. For simplicity, the methods described below are generally described as being performed by DPS 100.

Referring now to FIG. 3, there is depicted a high-level flow-chart illustrating a method for applying a suitable exposure table to at least one image sensor, in accordance with one or more embodiments of the present disclosure.

Method 300 commences at initiator block 301 and proceeds to block 302 at which point a condition that triggers an update to a current exposure table in use by at least one image sensor is detected. At block 304, DPS 100 extracts and determines a suitable exposure table for the at least one image sensor. DPS 100 then determines whether the suitable exposure table is equivalent to the current exposure table for the at least one image sensor (block 306). In response to determining that the suitable exposure table is equivalent to the current exposure table (block 308), the method terminates at block 330. In response to determining that the suitable exposure table is not equivalent to the current exposure table (block 308), the method continues to block 310 where DPS 100 applies the suitable exposure table to the at least one image sensor. The method then terminates at block 320.

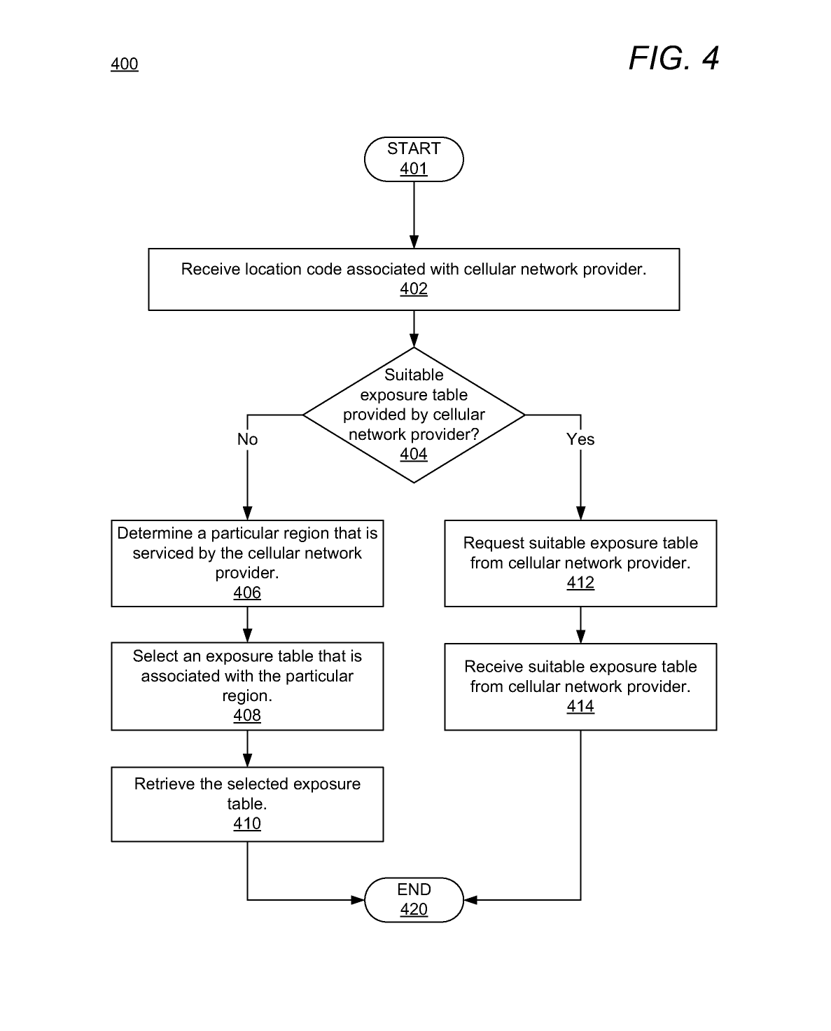

Referring now to FIG. 4, there is depicted a high-level flow-chart illustrating a method for retrieving an exposure table for potential use by at least one image sensor responsive to receiving a location code associated with a cellular network provider, in accordance with one or more embodiments of the present disclosure. Method 400 commences at initiator block 401. At block 402 DPS 100 receives a location code associated with a cellular network provider. At optional block 404, DPS 100 determines whether a suitable exposure table will be provided by the cellular network provider. In one embodiment, this determination may be made based on one or more data packets received from the cellular network provider that indicate whether the cellular network provider will provide the suitable exposure table. In another embodiment, DPS 100 may wait for a predetermined amount of time to receive the suitable exposure table before determining that the suitable exposure table will not be provided by the cellular network provider. In still another embodiment, step 404 is omitted completely and the method proceeds directly from block 402 to block 406.

In response to determining that the suitable exposure table will not be provided by the cellular network provider, the method continues to block 406 where DPS 100 determines a particular region that is serviced by the cellular network provider. DPS 100 then selects an exposure table that is associated with the particular region (block 408). At block 410 the selected exposure table is retrieved and applied. The method then terminates at block 420.

In response to determining at block 404 that the suitable exposure table will be provided by the cellular network provider, the method continues to block 412 where DPS 100 requests a suitable exposure from the cellular network provider. At block 414, DPS 100 receives the selected exposure table from the cellular network provider. The method then terminates at block 420.

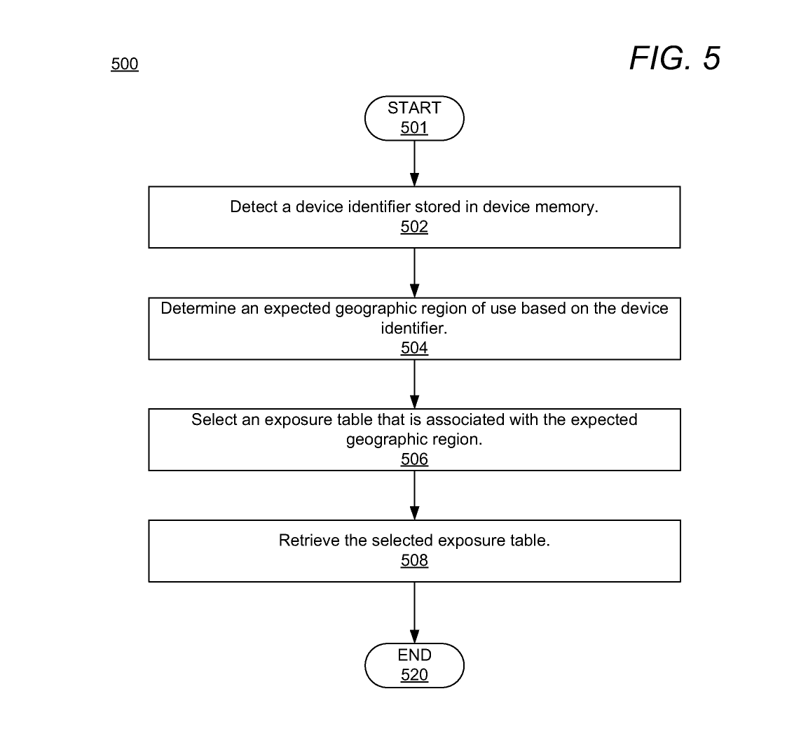

Referring now to FIG. 5, there is depicted a high-level flow-chart illustrating a method for retrieving an exposure table for potential use by at least one image sensor of a device based on a device identifier associated with the device, in accordance with one or more embodiments of the present disclosure. Method 500 commences at initiator block 501. At block 502, DPS 100 detects or retrieves a device identifier stored within a memory of DPS 100. At block 504, DPS 100 determines an expected geographic region of use for the device based on the device identifier. At block 506, DPS 100 selects, as a suitable exposure table, an exposure table that is associated with the expected geographic region of use from among a plurality of locally and/or remotely stored exposure tables. DPS 100 then retrieves and applies the selected exposure table (block 508). The method then terminates at block 520.

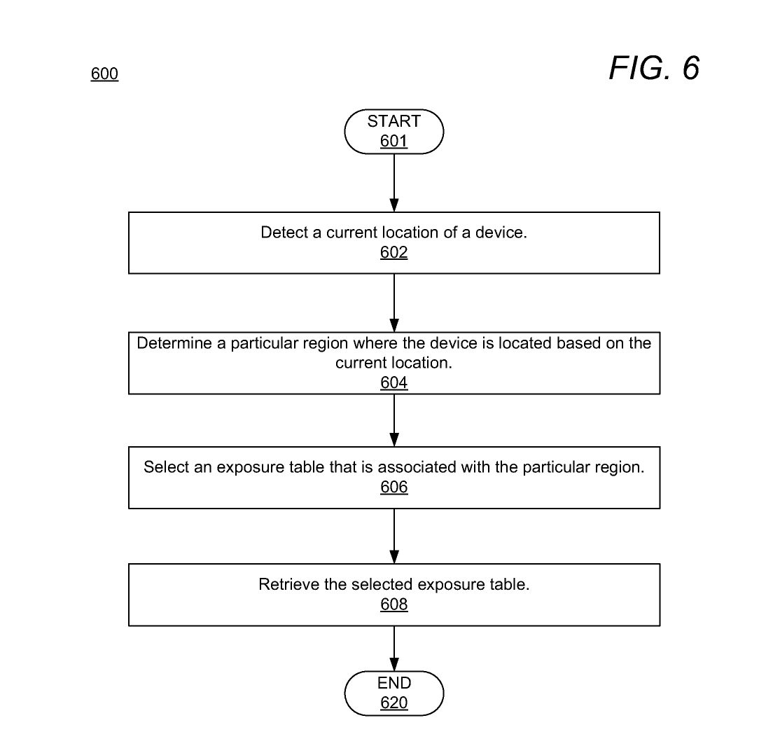

Referring now to FIG. 6, there is depicted a high-level flow-chart illustrating a method for retrieving an exposure table used by at least one image sensor of a device based on a current location of the device, in accordance with one or more embodiments of the present disclosure. Method 600 commences at initiator block 601. At block 602 DPS 100 detects its current location. At block 604, DPS 100 determines a particular region that DPS 100 is located within based on the current location. DPS 100 may, lookup the particular region using, for example, a mapping software or a correlation database that associates locations and regions. In one embodiment, the mapping software and/or the correlation database may be stored locally on DPS 100. In another embodiment, the mapping software and/or the correlation database may be partially or completely stored at a remote service or device (e.g., server 165).

At block 606 DPS 100 selects, as a suitable exposure table from among a plurality of locally and/or remotely stored exposure tables, an exposure table that is associated with the particular region. DPS 100 then retrieves the selected suitable exposure table (block 608). The method then terminates at block 620.

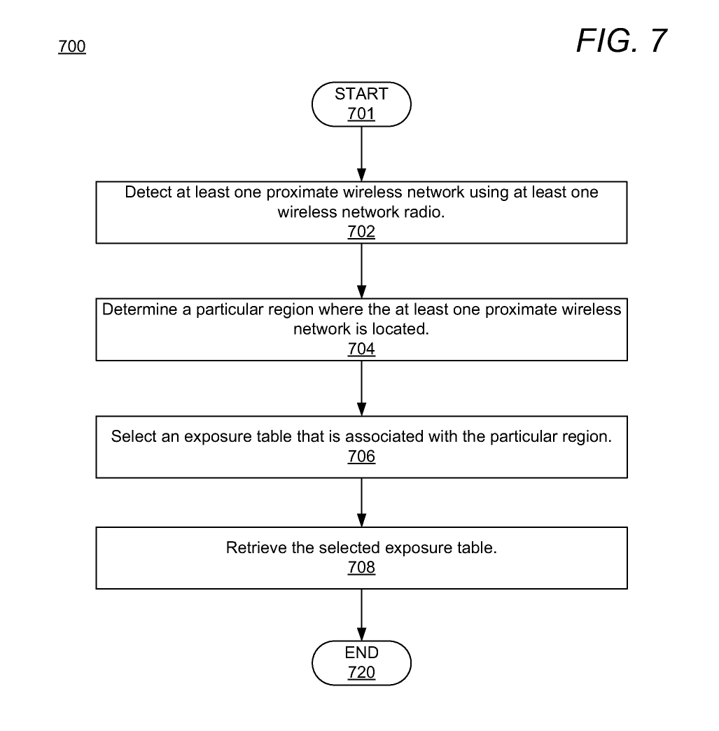

Referring now to FIG. 7, there is depicted a high-level flow-chart illustrating a method for retrieving an exposure table used by at least one image sensor in response to detecting at least one proximate wireless network, in accordance with one or more embodiments of the present disclosure. Method 700 commences at initiator block 701. At block 702, DPS 100 detects at least one proximate wireless network using at least one wireless network radio. At block 704, DPS 100 determines a particular region where the at least one proximate wireless network is located. At block 706, DPS 100 selects, as a suitable exposure table, an exposure table that is associated with the particular region from among a plurality of locally and/or remotely stored exposure tables. DPS 100 then retrieves the selected exposure table (block 708). The method then terminates at block 720.

In the above-described flow charts, one or more of the method processes may be embodied in a computer readable device containing computer readable code such that a series of steps are performed when the computer readable code is executed on a computing device. In some implementations, certain steps of the methods are combined, performed simultaneously or in a different order, or perhaps omitted, without deviating from the scope of the disclosure. Thus, while the method steps are described and illustrated in a particular sequence, use of a specific sequence of steps is not meant to imply any limitations on the disclosure. Changes may be made with regards to the sequence of steps without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object oriented programming language, without limitation. These computer program instructions may be provided to a processor of a general purpose computer, special purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible medium that can contain, or store a program for use by or in connection with an instruction execution system, apparatus, or device.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A method comprising:
detecting a condition that triggers an update to a current exposure table that is used by at least one image sensor of a device; and
in response to detecting the condition:
determining a suitable exposure table for potential use by the at least one image sensor;
determining whether the suitable exposure table is equivalent to the current exposure table; and
in response to determining the suitable exposure table is not equivalent to the current exposure table, applying the suitable exposure table to the at least one image sensor.

2. The method of claim 1, wherein the device comprises at least one cellular radio, and wherein determining the suitable exposure table further comprises:
receiving, via the at least one cellular radio, a location code that is associated with a cellular network provider;
determining a particular region that is serviced by the cellular network provider based on the location code;
selecting an exposure table that is associated with the particular region, wherein the suitable exposure table defines one or more exposure timings that may be applied to the at least one image sensor in order to prevent any banding regions from being captured by the at least one image sensor in the particular region, and wherein the one or more exposure timings are based on a frequency of an alternating current (AC) power source in the particular region; and
retrieving the selected exposure table as the suitable exposure table.

3. The method of claim 1, wherein determining the suitable exposure table further comprises:
detecting a device identifier associated with the device;
determining an expected geographic region of use for the device based on the device identifier;
selecting an exposure table that is associated with the expected geographic region of use, wherein the suitable exposure table defines one or more exposure timings that may be applied to the at least one image sensor in order to prevent any banding regions from being captured by the at least one image sensor in the expected geographic region, and wherein the one or more exposure timings are based on a frequency of an alternating current (AC) power source in the expected geographic region; and
retrieving the selected exposure table as the suitable exposure table.

4. The method of claim 3, wherein the device identifier comprises one or more of a stock keeping unit (SKU) and a serial number.

5. The method of claim 1, wherein the device further comprises at least one of a global positioning satellite (GPS) sensor and a radio frequency identification (RFID) sensor, and wherein determining the suitable exposure table further comprises:
detecting, via the at least one of at least one of the GPS sensor and the RFID sensor, a current location of the device;
determining, based on current location, a particular region in which the device is located;
selecting an exposure table that is associated with the particular region, wherein the suitable exposure table defines one or more exposure timings that may be applied to the at least one image sensor in order to prevent any banding regions from being captured by the at least one image sensor in the particular region, and wherein the one or more exposure timings are based on a frequency of an alternating current (AC) power source in the particular region; and
retrieving the selected exposure table as the suitable exposure table.

6. The method of claim 1, wherein the device further comprises at least one wireless network radio, and wherein determining the suitable exposure table further comprises:
detecting at least one proximate wireless network using the at least one wireless network radio;
determining a particular region where the detected at least one proximate wireless network is located;
selecting an exposure table that is associated with the particular region, wherein the suitable exposure table defines one or more exposure timings that may be applied to the at least one image sensor in order to prevent any banding regions from being captured by the at least one image sensor in the particular region, and wherein the one or more exposure timings are based on a frequency of an alternating current (AC) power source in the particular region; and
retrieving the selected exposure table as the suitable exposure table;

7. The method of claim 6, wherein the least one proximate wireless network comprises at least one of a personal area network and a wireless local area network.

8. The method of claim 1, wherein the condition comprises at least one of:
detecting a launch of a camera application stored on the device that interfaces with the at least one image sensor;
booting of the device;
detecting a change in a personal area network that the device is connected to;
detecting a change in a wireless local area network that the device is connected to; and
detecting a change in a cellular network that the device is connected to.

9. A device comprising:
a memory comprising a firmware;
at least one image sensor;
a processor that is coupled to the memory and the at least one image sensor and which generates a plurality of processing modules comprising a first module that detects a condition that triggers an update to a current exposure table that is used by the at least one image sensor; and
in response to detecting the condition:
the processor determines a suitable exposure table for potential use by the at least one image sensor;
the processor determines whether the suitable exposure table is equivalent to the current exposure table; and
in response to determining the suitable exposure table is not equivalent to the current exposure table, the processor configures the at least one image sensor based on the suitable exposure table.

10. The device of claim 9 further comprising at least one cellular radio, and wherein in response to the first module detecting the condition:
the processor receives, via the at least one cellular radio, a location code that is associated with a cellular network provider;
the processor determines a particular region that is serviced by the cellular network provider based on the location code;
the processor selects an exposure table that is associated with the particular region, wherein the suitable exposure table defines one or more exposure timings that may be applied to the at least one image sensor in order to prevent any banding regions from being captured by the at least one image sensor in the particular region, and wherein the one or more exposure timings are based on a frequency of an alternating current (AC) power source in the particular region; and
retrieves the selected exposure table as the suitable exposure table.

11. The device of claim 9, wherein in response to the first module detecting the condition:
the processor detects a device identifier associated with the device;
the processor determines an expected geographic region of use for the device based on the device identifier;
the processor selects an exposure table that is associated with the expected geographic region of use, wherein the suitable exposure table defines one or more exposure timings that may be applied to the at least one image sensor in order to prevent any banding regions from being captured by the at least one image sensor in the expected geographic region, and wherein the one or more exposure timings are based on a frequency of an alternating current (AC) power source in the expected geographic region; and
the processor retrieves the selected exposure table as the suitable exposure table.

12. The device of claim 11, wherein the device identifier comprises one or more of a stock keeping unit (SKU) and a serial number.

13. The device of claim 9, further comprising at least one of a global positioning satellite (GPS) sensor and a radio frequency identification (RFID) sensor, and wherein in response to the first module detecting the condition:
the processor detects, via the at least one of at least one of the GPS sensor and the RFID sensor, a current location of the device;
the processor determines, based on current location, a particular region in which the device is located;
the processor selects an exposure table that is associated with the particular region, wherein the suitable exposure table defines one or more exposure timings that may be applied to the at least one image sensor in order to prevent any banding regions from being captured by the at least one image sensor in the particular region, and wherein the one or more exposure timings are based on a frequency of an alternating current (AC) power source in the particular region; and
the processor retrieves the selected exposure table as the suitable exposure table.

14. The device of claim 9, further comprising at least one wireless network radio, and wherein in response to the first module detecting the condition:
the processor detects at least one proximate wireless network using the at least one wireless network radio;
the processor determines a particular region where the detected at least one proximate wireless network is located;
the processor selects an exposure table that is associated with the particular region, wherein the suitable exposure table defines one or more exposure timings that may be applied to the at least one image sensor in order to prevent any banding regions from being captured by the at least one image sensor in the particular region, and wherein the one or more exposure timings are based on a frequency of an alternating current (AC) power source in the particular region; and
the processor retrieves the selected exposure table as the suitable exposure table.

15. The device of claim 14, wherein the least one proximate wireless network comprises one or more of a personal area network and a wireless local area network.

16. The device of claim 9, wherein the condition further comprises at least one of:
a launch of a camera application stored in the memory that interfaces with the at least one image sensor;
an initialization of a boot of the device;
a change in a personal area network that the device is connected to;
a change in a wireless local area network that the device is connected to; and
a change in a cellular network that the device is connected to.

17. A computer program product comprising:
a computer readable storage device; and
program code on the computer readable storage device that when executed within a processor associated with a device that has at least one image sensor, the program code enables the device to provide the functionality of:
detecting a condition that triggers an update to a current exposure table that is used by the at least one image sensor; and
in response to detecting the condition:
determining a suitable exposure table for potential use by the at least one image sensor;
determining whether the suitable exposure table is equivalent to the current exposure table; and
in response to determining the suitable exposure table is not equivalent to the current exposure table, applying the suitable exposure table to the at least one image sensor.

18. The computer program product of claim 17, wherein the device comprises at least one cellular radio, and wherein determining the suitable exposure table further comprises:
receiving, via the at least one cellular radio, a location code that is associated with a cellular network provider;
determining a particular region that is serviced by the cellular network provider based on the location code;
selecting an exposure table that is associated with the particular region, wherein the suitable exposure table defines one or more exposure timings that may be applied to the at least one image sensor in order to prevent any banding regions from being captured by the at least one image sensor in the particular region, and wherein the one or more exposure timings are based on a frequency of an alternating current (AC) power source in the particular region; and
retrieving the selected exposure table as the suitable exposure table.
